(19) United States
(12) Patent Application Publication
(10) Pub. No.: US 2015/0301669 A1
(43) Pub. Date: Oct. 22, 2015

(54) INPUT DEVICE, DISPLAY DEVICE, AND ELECTRONIC APPARATUS

(71) Applicant: KYOCERA Corporation, Kyoto-shi, Kyoto (JP)

(72) Inventor: Yoshio MIYAZAKI, Kirishima-shi (JP)

(73) Assignee: KYOCERA Corporation, Kyoto-shi, Kyoto (JP)

(21) Appl. No.: 14/439,026

(22) PCT Filed: Oct. 15, 2013
(86) PCT No.: PCT/JP2013/077939

§ 371 Date: Apr. 28, 2015

(30) Foreign Application Priority Data
Oct. 30, 2012 (JP) 2012-239225

(51) Int. Cl. G06F 3/041

(52) U.S. Cl. CPC G06F 3/0412

(57) ABSTRACT

An input device includes a substrate including a first main surface and a second main surface positioned at a side opposite to the first main surface, a position detecting member provided, on the second main surface of the substrate, and a resin member provided on the first main surface of the substrate, wherein the resin member is formed in a convex shape in a direction getting away from the first main surface of the substrate. Preferably, the substrate is made of glass or plastic.

### CROSS-REFERENCE TO RELATED APPLICATIONS

This application is national stage application of International Application No. PCT/JP2013/077939, filed on Oct. 15, 2013, which designates the United States, incorporated herein by reference, and which claims the benefit of priority from Japanese Patent Application No. 2012-239225, filed Oct. 30, 2012, the entire contents of which are incorporated herein by reference.

### FIELD

The present invention relates to an input device, a display device, and an electronic apparatus.

### BACKGROUND

In the past, input devices in which a position detecting member is provided on a substrate made of, for example, glass or plastic have been known. In such input devices, in order to improve operability or design property, an operation surface of the substrate is formed, in a convex shape (for example, see Patent Literature 1).

However, for example, when the input device is incorporated into a housing, since the operation surface of the substrate has the convex shape, the operation surface is likely to protrude outside the housing. If the operation surface of the substrate protrudes outside the housing, mechanical shock is likely to be applied to the operation surface, and the substrate is likely to crack or wane.

### Patent Literature 1: Japanese Patent Application Laid-open No. 2010-244336

### SUMMARY

An input device according to one aspect of the present invention includes a substrate including a first main surface and a second main surface positioned at a side opposite to the first main surface, a position detecting member provided on the second main surface of the substrate, and a resin member provided on the first main surface of the substrate, wherein the resin member is formed in a convex shape in a direction getting away from the first main surface of the substrate.

A display device according to one aspect of the present invention includes the input device, a display panel arranged to face the second main surface of the substrate in the input device, and a first housing accommodating the display panel.

An electronic apparatus according to one aspect of the present invention includes the display device, wherein the first housing in the display device functions as a housing for the electronic apparatus.

An electronic apparatus according to the other aspect of the present invention includes the display device, and a second housing accommodating the display device.

### BRIEF DESCRIPTION OF DRAWINGS

FIG. 1 is a plane view illustrating a schematic configuration of an input device according to the present embodiment.

FIG. 2 is a cross-sectional view taken along line I-I of FIG. 1.

FIG. 3 is a cross-sectional view taken along line II-II of FIG. 1.

FIG. 4 is a plane view illustrating a schematic configuration of a display device according to the present embodiment.

FIG. 5 is a cross-sectional view taken along line III-III of FIG. 4.

FIG. 6 is a perspective view illustrating a schematic configuration of a mobile terminal according to the present embodiment.

FIG. 7 is a plane view illustrating a schematic configuration of an input device according to a first modified example.

FIG. 8 is a cross-sectional view taken along line IV-IV of FIG. 7.

FIG. 9 is a cross-sectional view taken along line V-V of FIG. 7.

FIG. 10 is a plan view illustrating an enlarged region A1 surrounded by an alternate long and short dash line illustrated in FIG. 9.

FIG. 11 is a plane view illustrating a schematic configuration of a display device according to the first modified example.

FIG. 12 is a cross-sectional view taken along line VI-VI of FIG. 11.

FIG. 13 is a plane view illustrating a schematic configuration of an input device according to a second modified example.

FIG. 14 is a cross-sectional view taken along line VII-VII of FIG. 13.

FIG. 15 is a cross-sectional view taken along line VIII-VIII of FIG. 13.

FIG. 16 is a plane view illustrating an enlarged region A2 surrounded by an alternate long and short dash line illustrated in FIG. 15.

FIG. 17 is a plane view illustrating a schematic configuration of an input device according to a third modified example.

FIG. 18 is a cross-sectional view taken along line IX-IX of FIG. 17.

FIG. 19 is a plane view illustrating a schematic configuration of an input device according to a fourth modified example.

FIG. 20 is a cross-sectional view taken along line X-X of FIG. 19.

FIG. 21 is a cross-sectional view a schematic configuration of an input device according to a fifth modified example.

### DESCRIPTION OF EMBODIMENTS

Hereinafter, embodiments of the present invention will be described with reference to the appended drawings.

The drawings referred to below illustrate main members necessary for describing the present invention among constitutional members according to an embodiment of the present invention in a simplified manner. Thus, an input device, a display device, and an electronic apparatus according to the present invention may include an arbitrary constitutional member that is not illustrated in the drawings referred to in this specification.

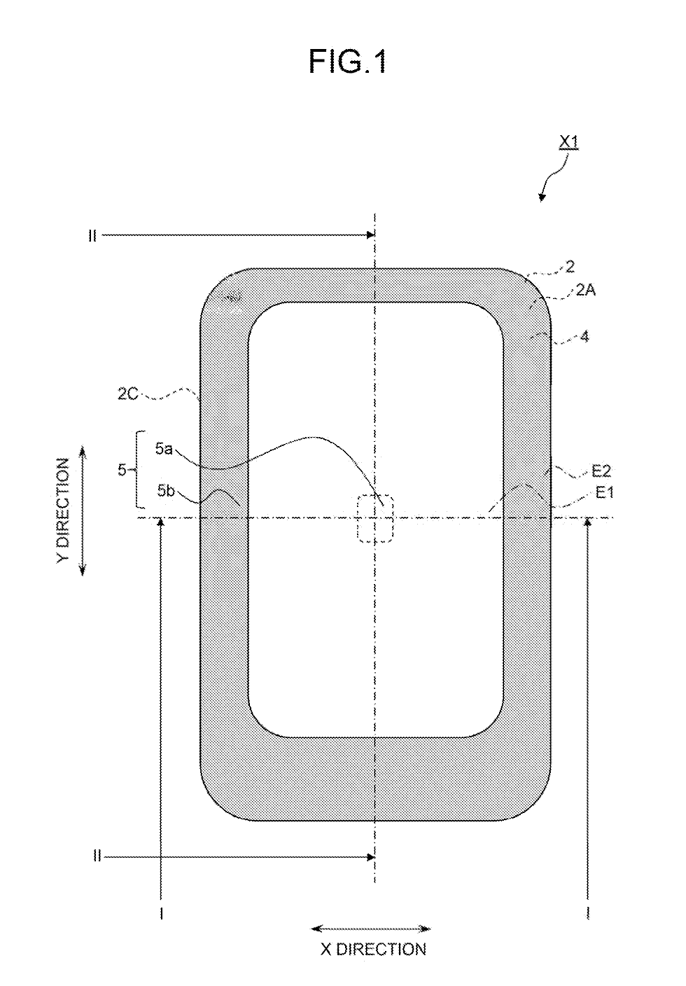

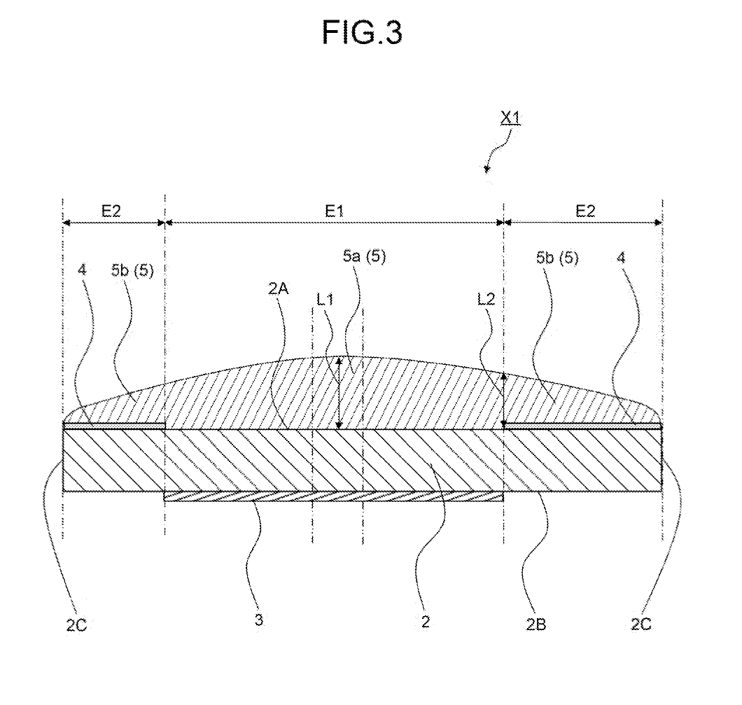

An input device X1 according to the present embodiment is a cover panel-integrated capacitive touch panel as illustrated in FIGS. 1 to 3. The input device X1 includes an input region E1 and a non-input region E2. The input region E1 is a region in which a user can perform an input operation. The non-input region E2 is a region in which it is difficult for the user to perform the input operation. The non-input region E2 according to the present embodiment is positioned outside the input region E1 to surround the input region E1, but not limited to this example. For example, the non-input region E2 may be positioned inside the input region E1.

The input device X1 is not limited to a cover panel-integrated capacitive type touch panel, and may be, for example, a stacked capacitive type touch panel, a resistive type touch panel, a surface acoustic wave type touch panel, an optical type touch panel, or an electromagnetic induction type touch panel.

The input device X1 includes a substrate 2, a position detecting member 3, a decorating member 4, and a resin member 5.

The substrate 2 has a role to support the position detecting member 3, the decorating member 4, and the resin member 5. In the present embodiment, the substrate 2 is made of glass or plastic. A high molecular compound such as polycarbonate, polyimide, or PET (polyethylene terephthalate) may be used as the plastic. The substrate 2 made of plastic is lower in modulus of elasticity than the substrate 2 made of glass, but higher in modulus of elasticity and more likely to crack or wane by the mechanical shock than the resin member 5 which will be described later.

The substrate 2 includes a first main surface 2A, a second main surface 2B, and end surfaces 2C. The first main surface 2A is positioned to be closer to the user side than the second main surface 2B. In other words, the user can perform the input operation on the first main surface 2A. The second main surface 2B is positioned on the side opposite to the first main surface 2A. In the present embodiment, the first main surface 2A and the second main surface 2B are substantially flat. The end surfaces 2C are positioned between the first main surface 2A and the second main surface 2B. Specifically, the end surfaces 2C refer to four surfaces adjacent to the first main surface 2A and the second main surface 2B.

The substrate 2 has an insulation property, and has translucency on light that is incident in a direction crossing the first main surface 2A and the second main surface 2B of the substrate 2. In this specification, “translucency” refers to a property of transmitting part or all of visible light.

In the input device X1, the substrate 2 has substantially a rectangular shape at a planar view, but not limited to this example. For example, the substrate 2 may have a circular shape, an elliptical shape, a polygonal shape.

The position detecting member 3 has a role to detect an operation position of the user on the first main surface 2A of the substrate 2. The position detecting member 3 is provided on a portion of the second main surface 2B of the substrate 2 corresponding to the input region E1. The position detecting member 3 may be provided to extend from the input region E1 to the non-input region E2.

Further, the position detecting member 3 may not be provided directly on the second main surface 2B of the substrata 2. Specifically, for example, when the input device X1 is a stacked capacitive type touch panel, the position detecting member 3 may foe provided on a detection substrate (not illustrated) arranged to face the second main surface 2B of the substrate 2. In this case, the second main surface 2B of the substrate 2 adheres to the detection substrate, for example, with an adhesive having translucency. In other words, the position detecting member 3 may be provided to be separated from the second main surface 2B of the substrate 2 with any other member interposed therebetween.

A conductive member having translucency may be used as a constitutional material of the position detecting member 3. Examples of the conductive member having translucency include indium tin oxide (ITO), indium zinc oxide (IZO), Al-doped zinc oxide (AZO), tin oxide, zinc oxide, and a conductive polymer. As a method of forming the position detecting member 3, for example, a film, made of such a material is formed on the second main surface 2B of the substrate 2 using a sputtering technique, a deposition technique, or a chemical vapor deposition (CVD) technique. Then, the surface of the film is coated with photosensitive resin, and the film is patterned into a certain shape through an exposure process, a development process, and an etching process, so that the position detecting member 3 is formed.

The decorating member 4 has a role to decorate the non-input region E2 of the input device X1 or a role to light-shield the non-input region E2 of the input device X1. In this specification, “light shielding” refers to blocking part or all of visible light by reflection or absorption. The decorating member 4 is provided on a portion of the first main surface 2A of the substrate 2 corresponding to the non-input region E2. The decorating member 4 may be provided on a portion of the second main surface 2B corresponding to the non-input region E2.

A resin material including a coloring material therein may be used as a constitutional material of the decorating member 4. Examples of the resin material include acrylic-based resin, epoxy-based resin, and silicon-based resin. Examples of the coloring material include carbon, titanium, and chromium. For example, a screen printing technique, a sputtering technique, a CVD technique, a deposition technique, or the like may be used as a method of forming the decorating member 4.

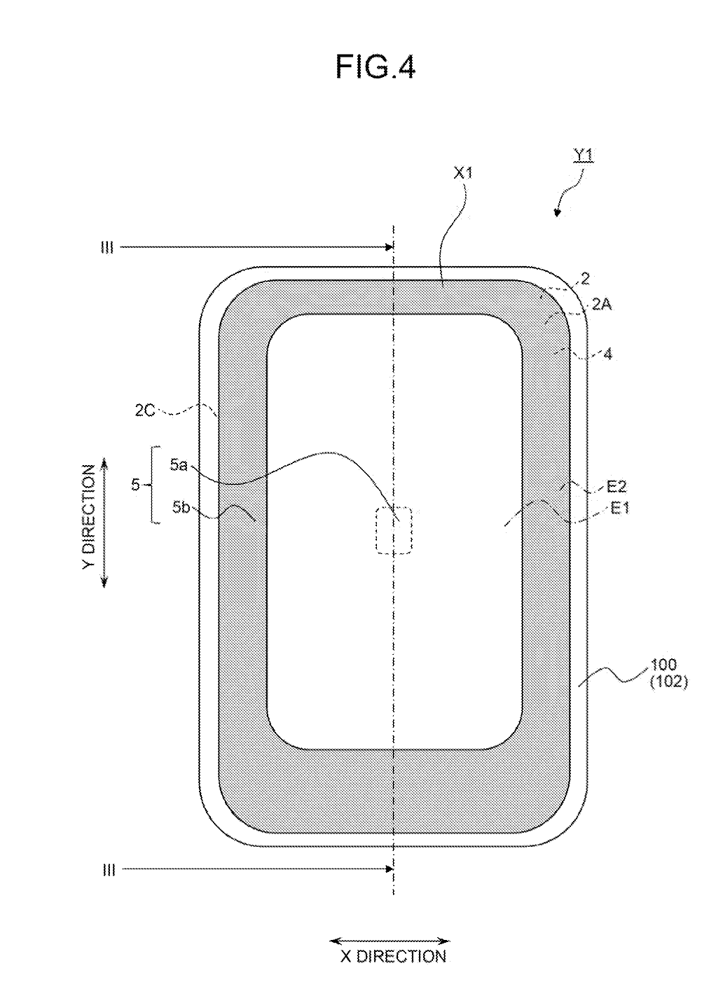

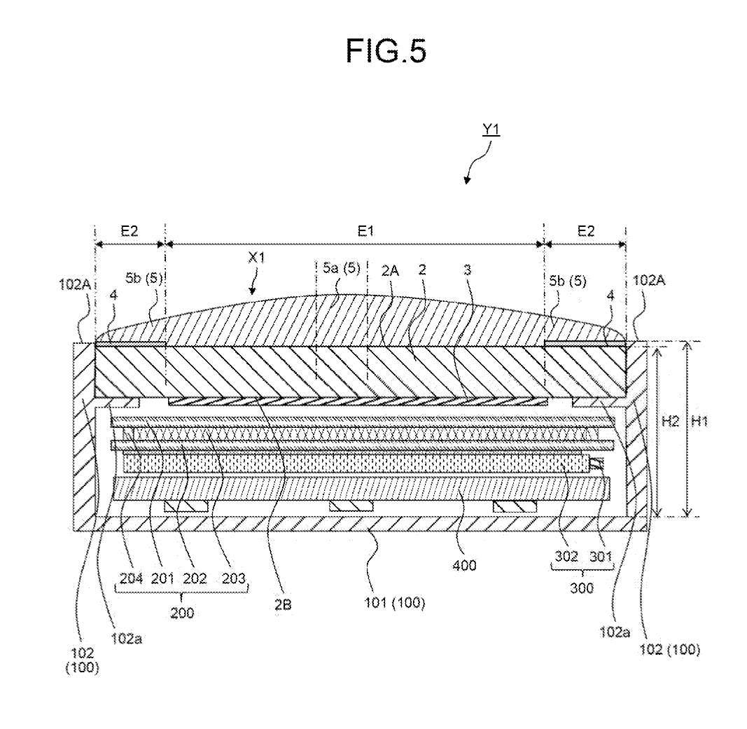

The resin member 5 has a role to protect the first main surface 2A of the substrate 2 so that the first main surface 2A of the substrate 2 is not damaged by the user's finger contact. The resin member 5 is provided on a portion of the first main surface 2A of the substrate 2 corresponding to the input region E1 and the non-input region E2. The resin member 5 may be provided only on a portion of. the first main surface 2A of the substrate 2 corresponding to the input region E1. Further, the resin member 5 may be provided only on a portion of the first main surface 2A of the substrate 2 corresponding to the input region E1. The resin, member 5 is formed in a convex shape in a direction getting away from the first main surface 2A of the substrate 2. Specifically, the resin member 5 has a convex surface. Thus, when the input device X1 is incorporated into a first housing 100 (see FIGS. 4 and 5), the operation surface (the surface of the resin member 5) of the input device X1 can be formed in the convex shape according to a design concept of a display device Y1, and thus the design property can be improved. Further, when the operation surface of the input device X1 can be formed in the convex shape, the user can have an operational feeling different from that when the operation surface is a flat surface.

The resin member 5 includes an apex portion 5a and an edge portion 5b. In the present embodiment, the apex portion 5a refers to a portion that is high in a height position with respect to a base portion 101 of the first housing 100 when the input device X1 is incorporated into the first housing 100. Specifically, for example, the apex portion 5a may refer to a portion surrounding an apex that is largest in a separation distance from the first main surface 2A of the substrate 2 to the surface of the resin member 5 in the resin member 5. Further, a range of a tenth ( 1/10) to a fifth (⅕) of a region in which the resin member 5 is positioned may be set as a region in which the apex portion 5a is positioned at a planar view. In the present embodiment, the apex portion 5a is positioned substantially at the center of the input region E1. Further, the apex portion 5a may be positioned substantially at the center of the input region E1 or may be positioned at the corner of the input region E1 or in the non-input region E2. Furthermore, in the present embodiment, the number of apex portions 5a is not limited to one, and there may be a plurality of apex portions 5a, The edge portion 5b is positioned outside the apex portion 5a.

The resin member 5 has translucency. Thus, it is possible to view an image displayed on a display panel 200 through the resin member 5 and the substrate 2 when the input device X1 is incorporated into the first housing 100. Further, the resin member 5 may be partially colored.

As a constitutional material of the resin member 5, for example, acrylic-based resin, silicon-based resin, polyolefin-based resin, or the like may be used. For example, the resin member 5 is formed in a certain shape using the resin material through a melt extrusion technique, a thermal press technique, an injection molding technique, or the like. When the resin member 5 is formed at a relatively small thickness, it is preferable that compression molding be performed. Further, the resin member 5 may be formed directly on the first main surface 2A of the substrate 2 or may adhere to the first main surface 2A of the substrate 2 through an adhesive (not illustrated).

As described above, in the input device X1, the resin member 5 is formed in a convex shape in a direction getting away from the first main surface 2A of the substrate 2. Therefore, in the input device X1, it is possible to reduce a possibility that the substrate 2 will crack or wane.

Specifically, in the input device according to the related art, an attempt to improve the design property or the operability of the input device by forming the first main surface of the substrate in the convex shape has been made. However, when the input device according to the related art is incorporated into the first housing, since the first main surface of the substrate has the convex shape, the first main surface is likely to protrude from the housing. Thus, for example, when the display device drops, mechanical shook is likely to be applied directly to the first main surface of the substrate. Here, glass or plastic configuring the substrate is a material that is likely to crack or wane by shock. Particularly, glass is a brittle material that hardly causes plastic deformation. Thus, when the substrate is made of glass, if stress by mechanical shock is concentrated on a fine scratch present on the first main surface of the substrate, the substrate is likely to crack or wane. Further, even when the substrate is made of plastic, since the substrate is higher in modulus of elasticity than the resin member, the substrate is likely to crack or wane.

In this regard, in the input device X1, the resin member 5 is formed in the convex shape in the direction getting away from the first main surface 2A of the substrate 2. Thus, when the input device X1 is incorporated into the first housing 100, a possibility that the first main surface 2A of the substrate 2 will protrude from, the first housing 100 can be reduced. Further, the resin material configuring the resin member 5 is a material that easily causes plastic deformation. Thus, it is possible to reduce a possibility that stress will be concentrated on a portion of the resin member 5 by mechanical shock even when the surface of the resin member 5 protrudes from the first housing 100 at a sectional view. As described above, in the input device X1, it is possible to reduce a possibility that the substrate 2 will crack or wane.

Further, it is preferable that a separation distance L1 from the surface of the apex portion 5a to the first main surface 2A of the substrate 2 be larger than a separation distance L2 from the surface of the edge portion 5b to the first main surface 2A of the substrate 2 as in the present embodiment. When the separation distance L1 is larger than the separation distance L2, it is possible to cause flatness of the surface of the resin member 5 to be larger than flatness of the first main surface 2A of the substrate 2. Thus, it is possible to reduce a possibility that the first main surface 2A of the substrate 2 will protrude outside the first housing 100 when the input device X1 is incorporated into the first housing 100. Further, the separation distance L1 can be set as the separation distance between the first main surface 2A and the surface of the apex portion 5a, for example, at the apex positioned at the side farthest from the first main surface 2A of the substrate 2 in the apex portion 5a. Furthermore, the separation distance L2 can be set as the separation distance between the surface of the edge portion 5b and the first main surface 2A of the substrate 2 at the position on the boundary between the input region E1 and the non-input region E2.

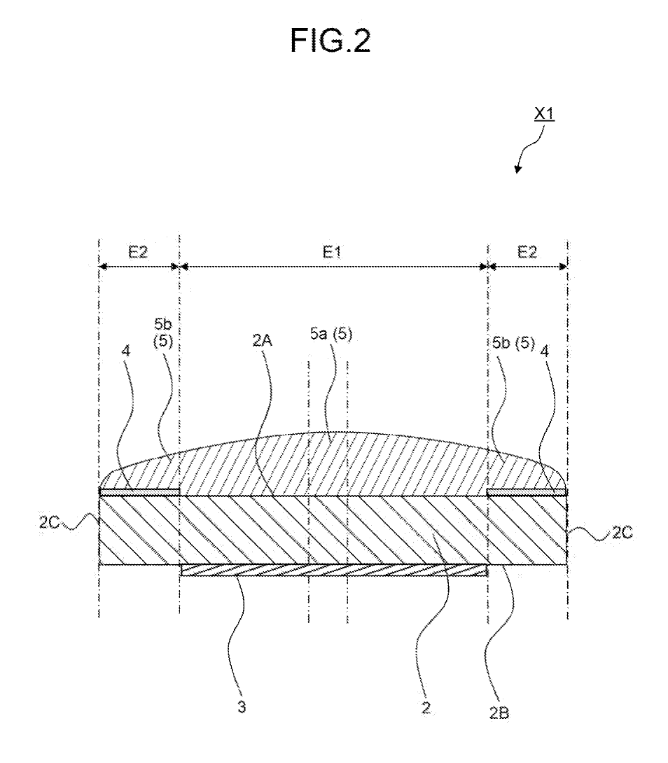

Further, it is preferable that the surface of the resin member 5 positioned on the first main surface 2A of the substrate 2 be curved as in the present embodiment. If the surface of the resin member 5 positioned on the first main surface 2A of the substrate 2 is the curved surface, it is possible to reduce a possibility that stress will be concentrated on a part of the surface of the resin member 5 when the input device X1 is incorporated into the first housing 100. Thus, it is possible to reduce a possibility that the resin member 5 will be scratched. Particularly, in the input device X1, the surface of the resin member 5 has a spherical shape. Specifically, the surface of the resin member 5 is curved in a cross-sectional view taken along line I-I of FIG. 2 that is a cross-sectional view in a short-side direction (an X direction in FIG. 1) of the substrate 2 and a cross-sectional view taken along line II-II that is a cross-sectional view in a long-side direction (a Y direction in FIG. 1) of the substrate 2 perpendicular to the short-side direction. Thus, it is possible to reduce a possibility that stress will be concentrated on a part of the surface of the resin member 5 when the input device X1 is incorporated into the first housing 100.

Next, a detection principle of the input device X1 will be described.

A position detection driver is electrically connected to the position detecting member 3 through an interconnection substrate (not illustrated). The position detection driver includes a power supply device. The power supply device supplies the position detecting member 3 with electric power. Here, when the user's finger serving as a conductor approaches, comes into contact with, or presses the portion of the first main surface 2A of the substrate 2 corresponding to the input region E1 through the resin member 5, capacitance occurs between the finger and the position detecting member 3. The position detection driver periodically detects a change in capacitance in the position detecting member 3, and detects a portion in which the detected capacitance has reached a certain value as an input position at which the user has performed the input operation. Thus, the input device X1 can detect the input position,

As described above, in the input device X1, it is possible to reduce a possibility that the substrate 2 will crack or wane.

Next, the display device Y1 equipped with the input device X1 will be described with reference to FIGS. 4 and 5. FIG. 4 is a plane view illustrating a schematic configuration of the display device Y1. FIG. 5 is a cross-sectional view taken along line III-III of FIG. 4.

The display device Y1 according to the present embodiment includes the input device X1, the first housing 100, the display panel 200, a backlight 300, and a circuit substrate 400 as illustrated in FIGS. 4 and 5.

The first housing 100 has a role to accommodate the input device X1, the display panel 200, the backlight 300, and the circuit substrate 400. The first housing 100 includes the base portion 101 and a frame portion 102. The base portion 101 has a role to receive the display panel 200 placed thereon, and is arranged to face the second main surface 2B of the substrate 2. In the present embodiment, the display panel 200 is placed above the base portion 101 with the circuit substrate 400 interposed therebetween. The frame portion 102 is positioned to surround the end surface 2C of the substrate 2. In the present embodiment, the frame portion 102 completely surrounds the four end surfaces 2C of the substrate 2, but the present invention is not limited to this example, and the frame portion 102 may be surround some end surfaces 2C of the substrate 2. The frame portion 102 includes a support portion 102a. The support portion 102a has a role to support the input device X1 from the second main surface 2B side of the substrate 2, and the input device X1 is placed on the support portion 102a. The frame portion 102 further includes an upper surface 102A positioned at the side farthest from the base portion 101.

Here, in the display device Y1, the height position of the upper surface 102A of the frame portion 102 with respect to the base portion 101 is higher than the height position of the first main surface 2A of the substrate 2 with respect to the base portion 101. Specifically, a separation distance H1 between the upper surface 102A of the frame portion 102 and the base portion 101 is larger than a separation distance H2 between the first main surface 2A of the substrate 2 and the base portion 101. Thus, in the display device Y1, it is possible to reduce a possibility that the first main surface 2A of the substrate 2 will protrude outside the first housing 100. Accordingly, for example, when the display device Y1 drops, it is possible to reduce a possibility that mechanical shock will be applied to the first main surface 2A of the substrate 2, and it is possible to reduce a possibility that the substrate 2 will crack or wane. Further, the height position of the upper surface 102A of the frame portion 102 with respect to the base portion 101 may be substantially the same as the height position of the first main surface 2A of tire substrate 2 with respect to the base portion 101. Specifically, the separation distance H1 may be substantially the same as the separation distance H2. When the separation distance H1 is substantially the same as the separation distance H2, it is possible to reduce a possibility that the substrate 2 will crack or wane as described above. In this specification, “substantially the same” means that a manufacturing error is included.

As a constitutional material of the first housing 100, for example, resin such as polycarbonate or metal such as stainless or aluminum may be used.

The display panel 200 has a role to display an image or the like. The display panel 200 includes an upper substrate 201, a lower substrate 202, a liquid crystal layer 203, and a sealing member 204.

The upper substrate 201 is arranged to face the second main surface 2B of the substrate 2 of the input device X1. The input device X1 may be provided on the upper substrate 201 with a fixing member interposed therebetween. Examples of the fixing member include a double-sided tape, thermosetting resin, ultraviolet curable resin, or a fixing tool such as a screw. The lower substrate 202 is arranged to face the upper substrate 201. For example, a transparent resin material such as glass or plastic may be used as constitutional materials of the upper substrate 201 and the lower substrate 202.

The liquid crystal layer 203 is a display member layer for displaying an image, and interposed between the upper substrate 201 and the lower substrate 202. Specifically, the liquid crystal layer 203 is sealed in a region between the upper substrate 201 and the lower substrate 202 through the upper substrate 201, the lower substrate 202, and the sealing member 204. In the display panel 200 according to the present embodiment, the liquid crystal layer 203 is equipped as the display member layer, but the present invention is not limited to this example. Instead of the liquid crystal layer 203, a plasma generating layer, an organic EL layer, or the like may be equipped.

The backlight 300 has a role to radiate light throughout the entire lower surface of the display panel 200. The backlight 300 is arranged at the back of the display panel 200. The backlight 300 includes a light source 301 and a light guide plate 302. The light source 301 is a member undertaking a role to radiate light toward the light guide plate 302, and configured with a light emitting diode (LED). The light source 301 may not be configured with an LED or may be configured with, for example, a cold cathode fluorescent lamp, a halogen lamp, a xenon lamp, or an electro-luminescence (EL). The light guide plate 302 is a member undertaking a role to guide light emitted from the light source 301 throughout the entire lower surface of the display panel 200 substantially uniformly. Further, when a display panel using a light-emitting element is used instead of the display panel 200, the backlight 300 may not be provided.

The circuit substrate 400 has a role to support the position detection driver of the input device X1, a control circuit that controls the display panel 200 and the backlight 300, and electronic parts such as a resistor and a capacitor. The circuit substrate 400 is arranged at the back of the backlight 300. The control circuit arranged on the circuit substrate 400 is electrically connected with the display panel 200 and the backlight 300 through an interconnection substrate (not illustrated).

As described above, it is possible to input various kinds of information to the display device Y1 by performing the input operation on the input region E1 of the input device X1 while causing the display panel 200 to be seen through the input device X1. Further, the input device X1 may be provided with a function of suggesting various senses of touch such as a sense or pressing, a sense of tracing, a tactile sense to the user who has input information. In this case, this can be implemented such that the substrate 2 of the input device X1 is equipped with one or more vibrators (for example, piezoelectric elements or the like), and the vibrators vibrate at a certain frequency when a certain input operation or a certain pressing load is detected.

As described above, since the display device Y1 is equipped with the input device X1, it is possible to reduce a possibility that the substrate 2 will crack or wane.

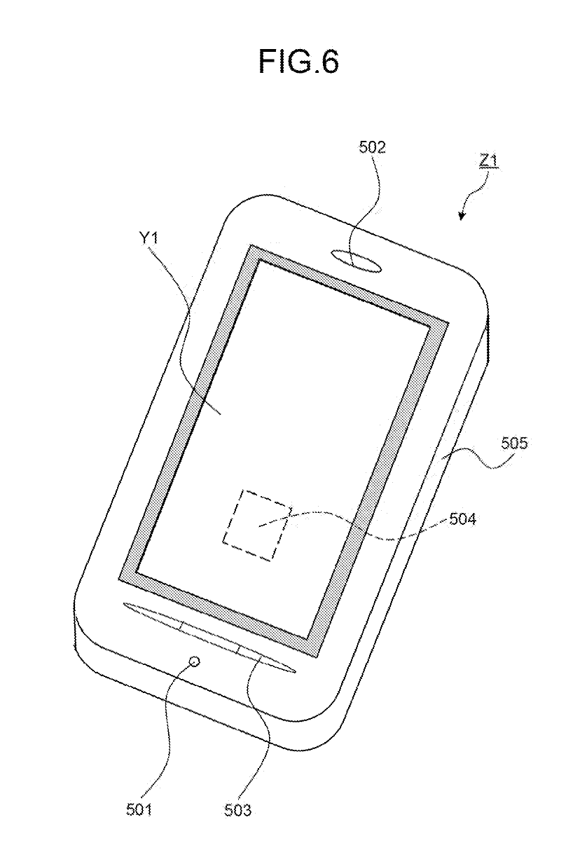

Next, a mobile terminal E1 equipped with the display device Y1 will be described with reference to FIG. 6, FIG. 6 is a perspective view of the mobile terminal Z1 equipped with the display device Y1.

The mobile terminal Z1 according to the present embodiment is a smartphone terminal as illustrated in FIG. 6. The mobile terminal Z1 is not limited to a smartphone terminal, and may be, for example, an electronic apparatus such as a mobile phone, a tablet terminal, or a personal, digital assistant (PDA).

The mobile terminal Z1 includes a display device Y1, a voice input unit 501, a voice output unit 502, a key input unit 503, a control unit 504, and a second housing 505.

The voice input unit 501 has a role to receive, for example, the user's voice, and is configured with a microphone or the like. The voice output unit 502 has a role to output the opposite party's voice, and is configured with an electromagnetic speaker, a piezoelectric speaker, or the like. The key input unit 503 is configured with a mechanical key. The key input unit 503 may be an operation key displayed on a display screen. The control unit 504 has a role to control the voice input unit 501, the voice output unit 502, and the key input unit 503. The second housing 505 has a role to accommodate the display device Y1, the voice input unit 501, the voice output unit 502, the key input unit 503, and the control unit 504. The same material as that of the first housing 100 may be used as a constitutional material of the second housing 505. The first housing 100 of the display device Y1 may function as a housing for the mobile terminal Z1. In other words, the second housing 505 may be integrated with the first housing; 100 of the display device Y1.

In addition, the mobile terminal Z1 may include a digital camera function unit, a one-segment broadcasting tuner, a near field wireless communication unit such as an infrared communication function unit, a wireless LAB module, various kinds of interfaces, or the like, but a detailed illustration and description thereof are omitted.

As described above, since the mobile terminal Z1 is equipped with the display device Y1, it is possible to reduce a possibility that the substrate 2 will crack or wane.

Here, the display device Y1 may be equipped in various electronic apparatuses such as an electronic organizer, a personal computer, a copy machine, a game terminal device, a television, a digital camera, a programmable display device used for industrial purpose, and the like instead of the mobile terminal Z1.

The above embodiment is a specific example of an embodiment of the present invention, and various modifications can be made. Next, several main modified examples will be described.

### FIRST MODIFIED EXAMPLE

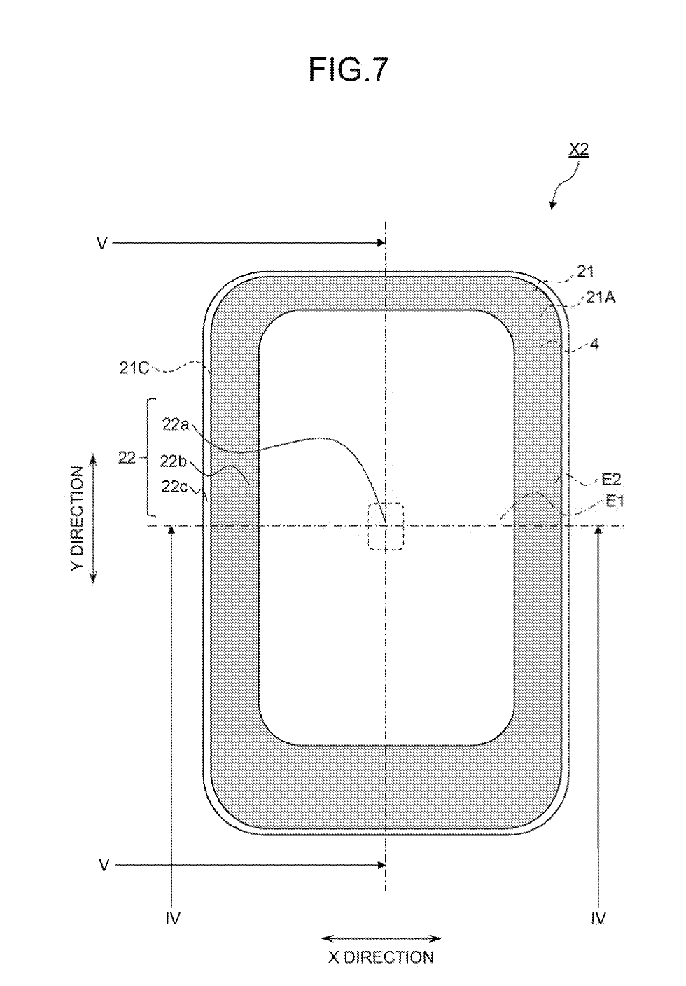

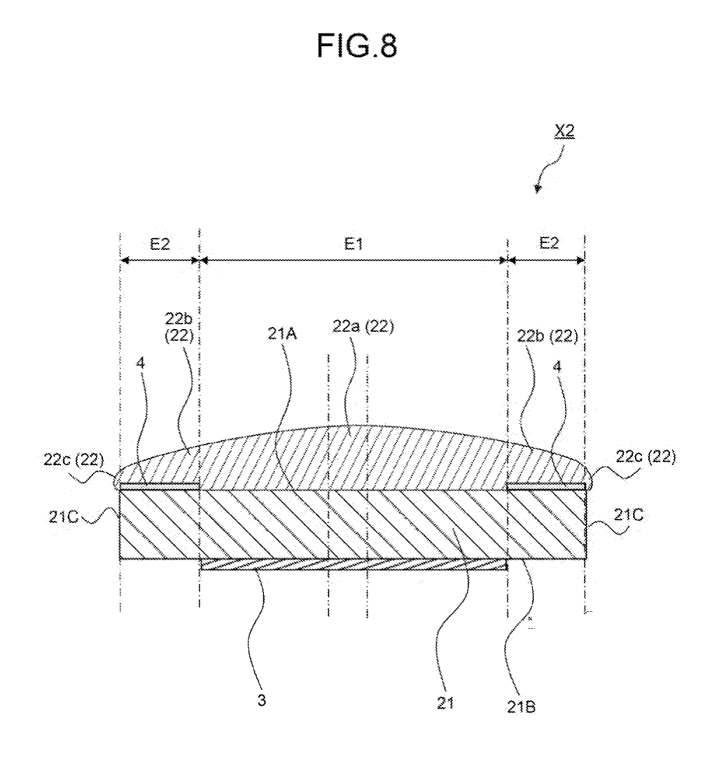

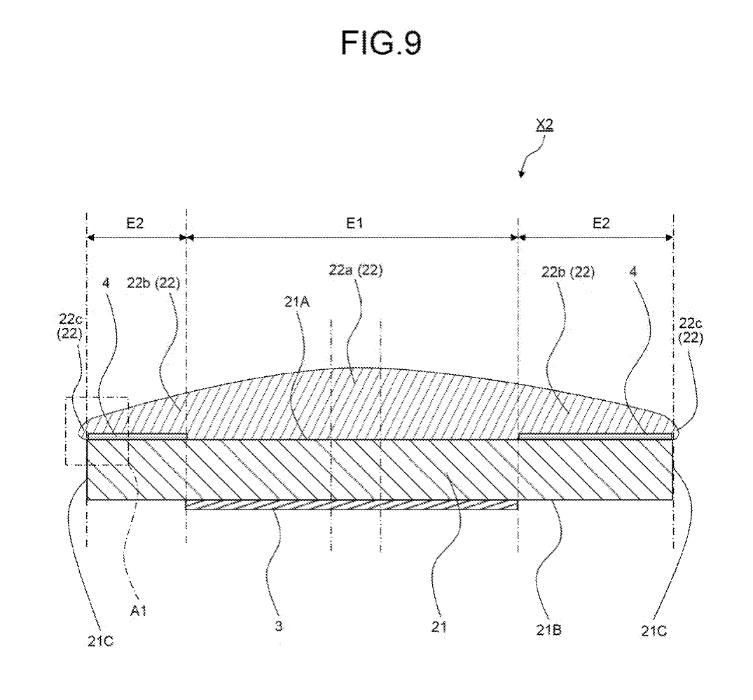

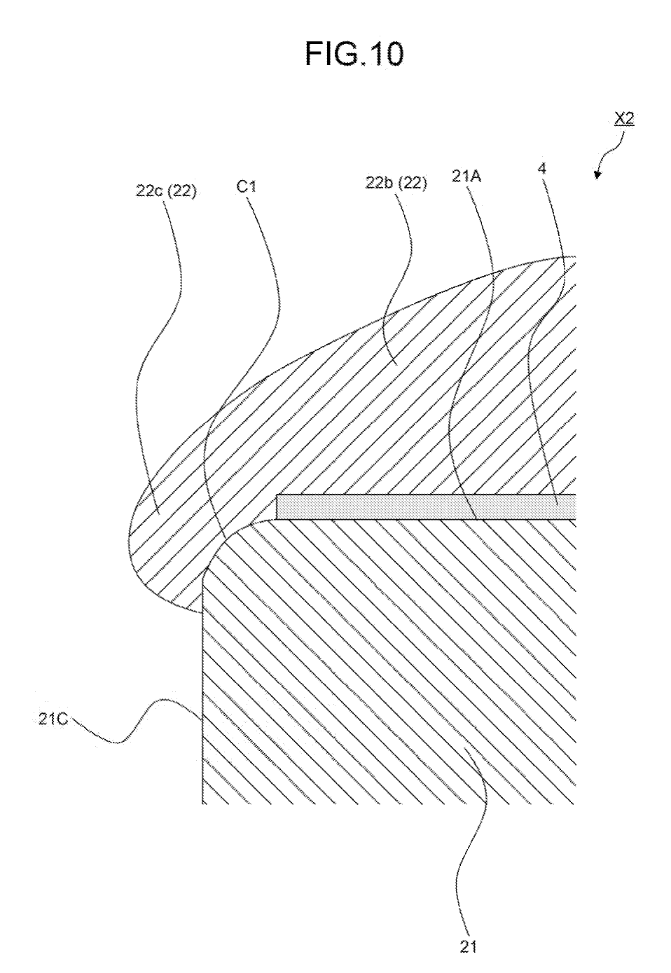

FIG. 7 is a plane view illustrating a schematic configuration of an input device X2 according to a first modified example. FIG. 8 is a cross-sectional view taken along line IV-IV of FIG. 7. FIG. 9 is a cross-sectional view taken along line V-V of FIG. 7. FIG. 10 is an enlarged view of a region A1 surrounded by an alternate long and short dash line illustrated in FIG. 9. In FIGS. 7 to 10, components having the same functions as in FIGS. 1 to 3 are denoted by the same reference numerals, and a detailed description thereof is omitted.

The input device X2 includes a substrate 21 and a resin member 22 instead of the substrate 2 and the resin member 5 equipped in the input device X1 as illustrated in FIGS. 7 to 10.

The substrate 21 is made of glass or plastic. The substrate 21 includes a first main surface 21A, a second main surface 21 B, and end surfaces 21C. The first main surface 21A is positioned to be closer to the user side than the second main surface 21B. The second main surface 21B is positioned at the side opposite to the first main surface 21A. The end surfaces 21C are positioned between the first main surface 21A and the second main surface 21B. Specifically, the end surfaces 21C refer to four surfaces adjacent to the first main surface 21A and the second main surface 21B.

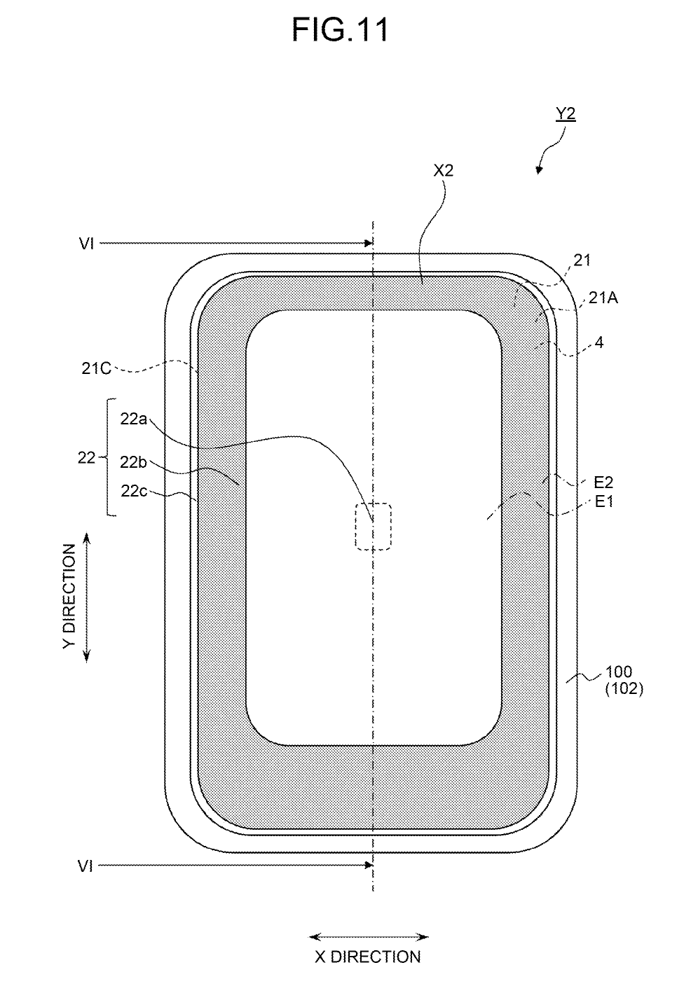

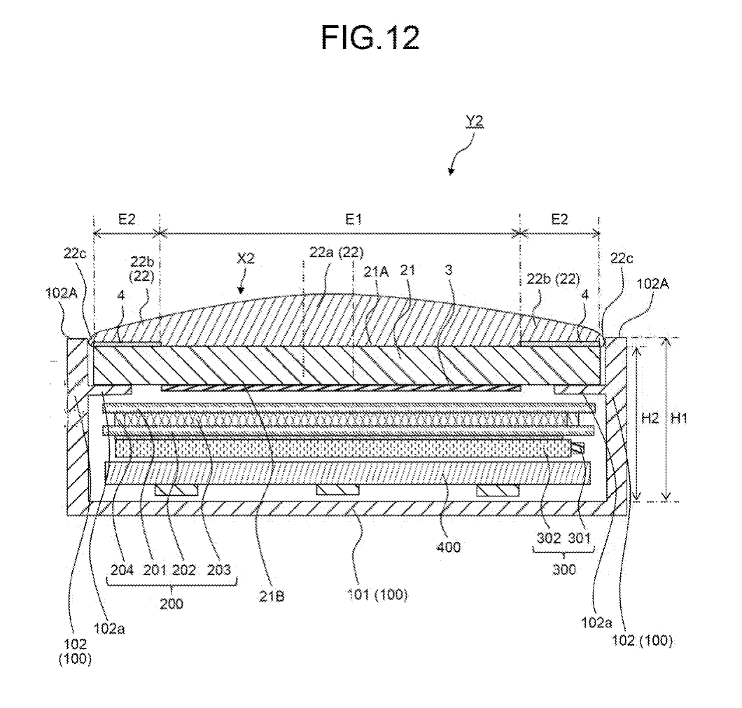

The resin member 22 is provided on portions of the first main surface 21A of the substrate 21 corresponding to the input region E1 and the non-input region E2. The resin member 22 is formed in a convex shape in a direction getting away from the first main surface 21A of the substrate 21. Specifically, the resin member 22 has a curved surface. The resin member 22 includes an apex portion 22a and an edge portion 22b. In the first modified example, the apex portion 22a refers to a portion that is high in a height position with respect to the base portion 101 of the first housing 100 when the input device X2 is incorporated into the first housing 100 (see FIGS. 11 and 12). The apex portion 22a is positioned substantially at the central portion of the input region E1. The edge portion 22b is positioned outside the apex portion 22a.

Here, a portion 22c of the edge portion 22b is positioned outside the substrate 21 at a planar view. Specifically, the portion 22c of the edge portion 22b is positioned outside a corner portion C1 formed by the first main surface 21A and the end surface 21C of the substrate 21 at a planar view. Thus, for example, when the input device X2 is incorporated into the first housing 100, the frame portion 102 of the first housing 100 comes into contact with the end surface 21C of the substrate 21, and thus it is possible to reduce a possibility that stress will be concentrated on a part of the end surface 21C of the substrate 21. Accordingly, in the input device X2, it is possible to reduce a possibility that the substrate 21 will Crack or wane.

Further, it is preferable that the portion 22c of the edge portion 22b surround the substrate 21 at a planar view as in the first modified example. Specifically, it is preferable that the portion 22c of the edge portion 22b surround ail of the four end surfaces 21C of the substrate 21 at a planar view. If the portion 22c of the edge portion 22b surrounds the substrate 21 at a planar view, it is possible to reduce a possibility that the four end surfaces 21C of the substrate 21 will come into contact with the frame portion 102 of the first housing 100 when the input device X2 is incorporated into the first housing 100. Accordingly, it is possible to reduce a possibility that the substrate 21 will crack or wane.

Further, in the first modified example, as illustrated in FIG. 10, the corner portion C1 formed by the first main surface 21A and the end surface 21C of the substrate 21 has a rounded surface. Furthermore, the resin member 22 covers the corner portion C1. Thus, in the input device X2, it is possible to reduce a possibility that the resin member 22 will be peeled off from the substrate 21.

Specifically, when the corner portion C1 has an acute angle, a contact area of the corner portion C1 and the resin member 22 is relatively small. At this time, adhesion strength between the corner portion C1 and the resin member 22 is likely to be reduced. Further, when the user performs the input operation by pressing the surface of the resin member 22, the corner portion C1 is a portion on which stress is likely to be concentrated by the pressing. Thus, when the corner portion C1 has an acute angle, there is a possibility that the resin member 22 is peeled off from the substrate 21 starting from the corner portion C1.

In this regard, in the first modified example, the corner portion C1 has a rounded surface. Thus, it is possible to reduce a possibility that adhesion strength will be reduced in or stress will be concentrated on the resin member 22 positioned on the corner portion C1. Accordingly, it is possible to reduce a possibility that the resin member 22 is peeled off from the substrate 2.

In the first modified example, the corner portion C1 has the rounded surface, but the present invention, is not limited to this example, and the corner portion C1 may have a C-shaped surface. When the corner portion C1 has a C-shaped surface, it is possible to reduce a possibility that adhesion strength will be reduced in or stress will be concentrated on the resin member 22 positioned on the corner portion C1 as described, above. Accordingly, it is possible to reduce a possibility that the resin member 22 is peeled off from the substrate 2.

Next, a display device Y2 equipped with the input device X2 will be described with reference to FIGS. 11 end 12. FIG. 11 is a plane view illustrating a schematic configuration of the display device Y1. FIG. 12 is a cross-sectional view taken along line VI-VI of FIG. 11. In FIGS. 11 and 12, components having the same function as in FIGS. 4 and 5 are denoted by the same reference numerals, and a detailed description thereof is omitted.

The display device Y2 is equipped with the input device X2 instead of the input device X1 equipped in the display device Y1 as illustrated in FIGS. 11 and 12.

The input device X2 is placed on the support portion 102a of the frame portion 102 of the first housing 100. The frame portion 102 of the first housing 100 is positioned to surround the end surface 21C of the substrate 21 in the input device X2. Here, the portion 22c of the edge portion 22b is positioned outside the substrate 21 at a planar view as described above. Thus, the portion 22c of the edge portion 22b is positioned to be closer to the frame portion 102 than the end surface 21C of the substrate 21 at a planar view. Further, the portion 22c of the edge portion 22b comes into contact with the frame portion 102. Thus, in the display device Y2, the input device X2 is supported on the frame portion 102 through the portion 22c of the edge portion 22b in an X direction and a Y direction. Accordingly, in the display device Y2, it is possible to reduce a possibility that the end surface 21C of the substrate 21 will come into contact with the frame portion 102, and it is possible to reduce a possibility that the substrate 21 will crack or wane.

### SECOND MODIFIED EXAMPLE

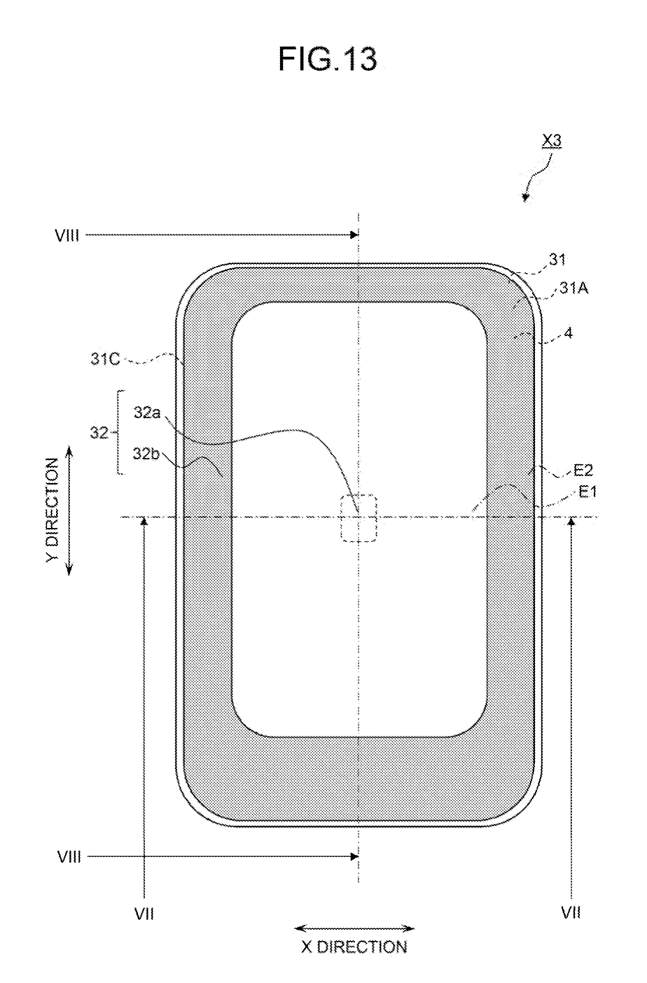

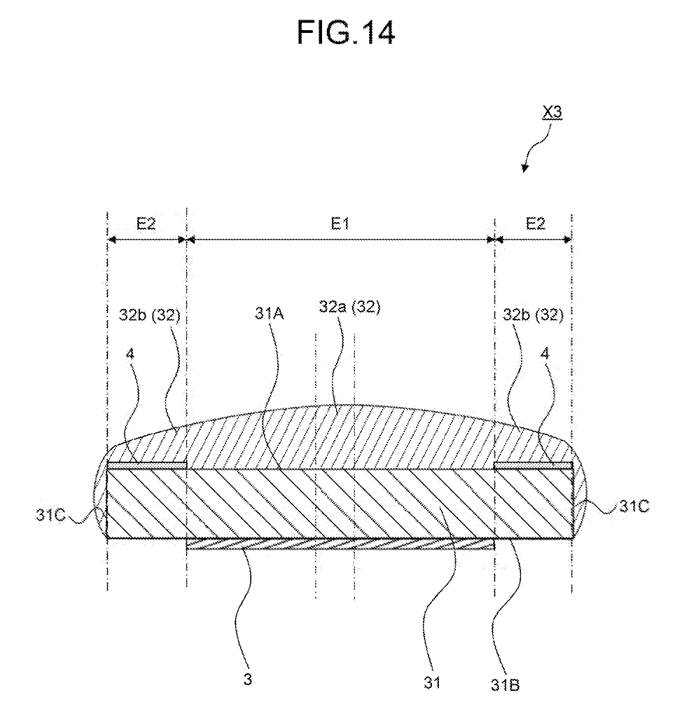

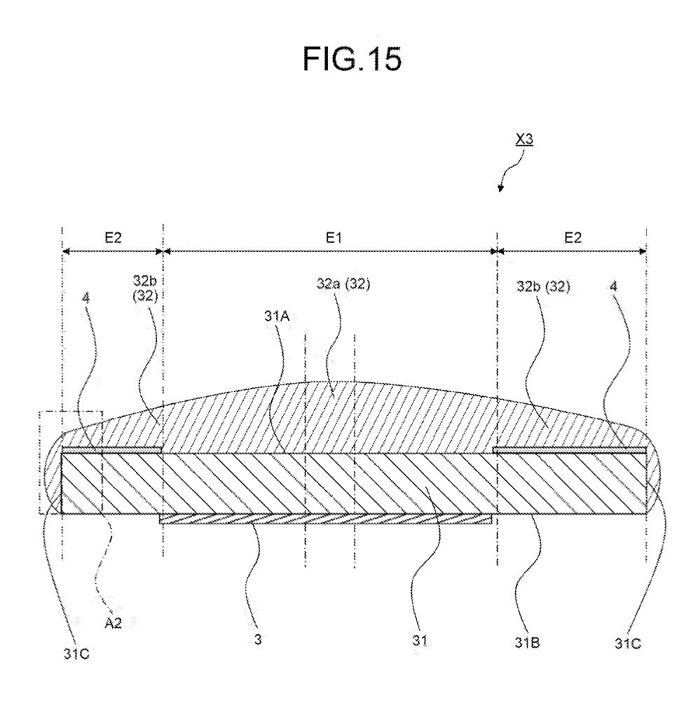

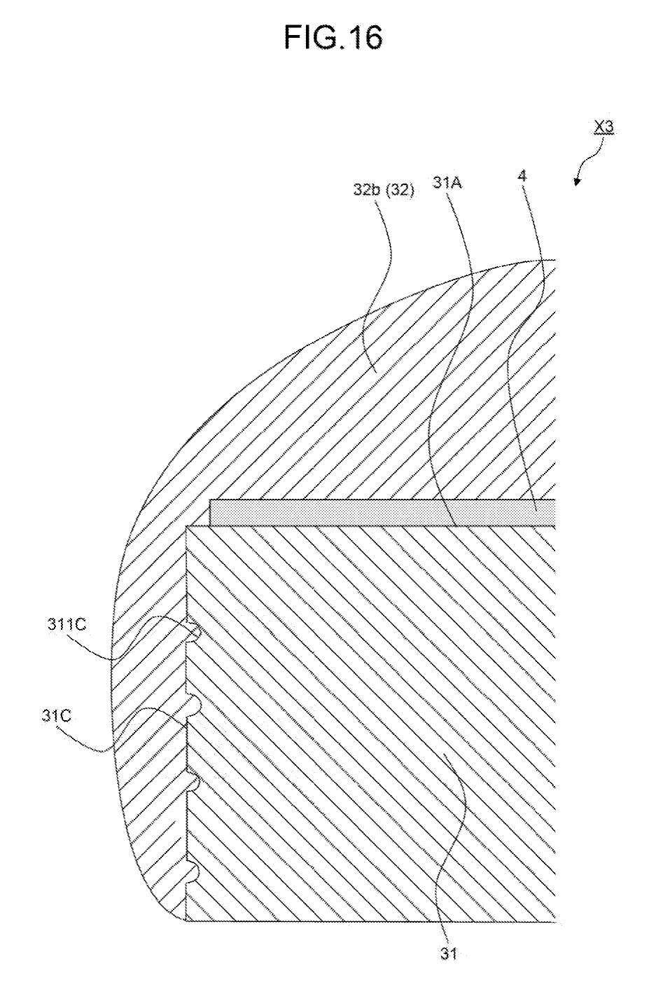

FIG. 13 is a plane view illustrating a schematic configuration of an input device X3 according to a second modified example. FIG. 14 is a cross-sectional view taken along line VII-VII of FIG. 13. FIG. 15 is a cross-sectional view taken along line VIII-VIII of FIG. 13. FIG. 16 is an enlarged view of a region A2 surrounded by an alternate long and short dash line illustrated in FIG. 15. In FIGS. 13 to 16, components having the same functions as in FIGS. 1 to 3 are denoted by the same reference numerals, and a detailed description thereof is omitted.

The input device X3 includes a substrate 31 and a resin member 32 instead of the substrate 2 and the resin member 5 equipped in the input device X1 as illustrated in FIGS. 13 to 16.

The substrate 31 is made of glass or plastic. The substrate 31 includes a first main surface 31A, a second main surface 31B, and an end surfaces 31C. The first main surface 31A is positioned to be closer to the user side than the second main surface 31B. The second main surface 31B is positioned at the side opposite to the first main surface 31A. The end surfaces 31C are positioned between the first main surface 31A and the second main surface 31B. Specifically, the end surfaces 31C refer to four surfaces adjacent to the first main surface 31A and the second main surface 31B.

The resin member 32 is provided to extend from the first main surface 31A of the substrate 31 to the end surfaces 31C The resin member 32 positioned on the first main surface 31A of the substrate 31 is formed in a convex shape in a direction getting away from the first main surface 31A of the substrate 31. Specifically, the resin member 32 positioned on the first main surface 31A of the substrate 31 has a curved surface. The resin member 32 positioned on the first main surface 31A of the substrate 31 includes an apex portion 32a and an. edge portion 32b. In the second modified example, the apex portion 32a refers to a portion that is high in a height position with respect to the base portion 101 of the first housing 100 when the input device X3 instead of the input device X1 is incorporated into the first housing 100. The apex portion 32a is positioned substantially at the central portion of the input region E1. The edge portion 32b is positioned outside the apex portion 32a.

As described above, in the input device X3, the resin member 32 is provided to extend from the first main surface 31A of the substrate 31 to the end surfaces 31C. Thus, for example, when the input device X3 instead of the input device X1 is incorporated into the first housing 100, the frame portion 102 of the first housing 100 comes into contact with the end surfaces 31C of the substrate 31, and thus it is possible to reduce a possibility that stress will be concentrated on a part of the end surfaces 31C of the substrate 31. Accordingly, in the input device X3, it is possible to further reduce a possibility that the substrate 31 will rack or wane.

In the second modified example, the resin member 32 covers all of the end surfaces 31C of the substrate 31, but the present invention is not limited to this example. The resin member 32 may cover some end surfaces 31C of the substrate 31. Further, the resin member 32 may be provided across the first main surface 31A, the end surfaces 31C, and the second main surface 31B of the substrate 31. When the resin member 32 is provided across the first main surface 31A, the end surfaces 31C, and the second main surface 31B of the substrate 31, it is possible to reduce a possibility that the resin member 32 will be peeled off from the substrate 31.

Further, the end surfaces 31C of the substrate 31 on which the resin member 32 is positioned is preferably larger in surface roughness than the first main surface 31A of the substrate 31 on which the resin member 32 is positioned. According to this configuration, for example, when the input device X3 instead of the input device X1 is incorporated into the first housing 100, it is possible to reduce a possibility that the resin member 32 positioned on the end surfaces 31C of the substrate 31 on which stress is likely to be concentrated by contact with the frame portion 102 of the first housing 100 will be peeled off from the substrate 31. The surface toughness may be measured, for example, using a stylus type surface roughness measuring instrument (JIS B 0651-1976) or a light wave interference type surface roughness measuring instrument (JIS B 0652-1973) as a surface roughness measuring method. The surface roughness may be calculated, for example, by employing ten point mean roughness.

The end surfaces 31C of the substrate 31 preferably has a concave portion 311C as illustrated in FIG. 16. Since the concave portion 311C is formed, the resin member 32 is embedded in the concave portion 311C. Thus, for example, when the input device X3 instead of the input device X1 is incorporated into the first housing 100, it is possible to reduce a possibility that the resin member 32 positioned on the end surfaces 31C of the substrate 31 on which stress is likely to be concentrated by contact with the frame portion 102 of the first housing 100 will be peeled off from the substrate 31.

The end surfaces 31C of the substrate 31 may include a convex portion instead of the concave portion 311C. When the end surfaces 31C of the substrate 31 includes the convex portion, a contact area between the resin member 32 and the end surfaces 31C of the substrate 31 is increased. Thus, it is possible to reduce a possibility that the substrate 31 will be peeled off from the resin member 32 as described above. Further, the end surfaces 31C of the substrate 31 may include both a convex portion and a concave portion.

The resin member 32 positioned on the end surfaces 31C of the substrate 31 preferably has a curved surface as in the second modified example. When the resin member 32 positioned on the end surfaces 31C of the substrate 31 has a curved surface, for example, when the input device X3 instead of the input device X1 is incorporated into the first housing 100, it is possible to reduce a possibility that stress will be concentrated on a part of the resin member 32 positioned on the end surfaces 31C of the substrate 31 by contact with the frame portion 102 of the first housing 100.

### THIRD MODIFIED EXAMPLE

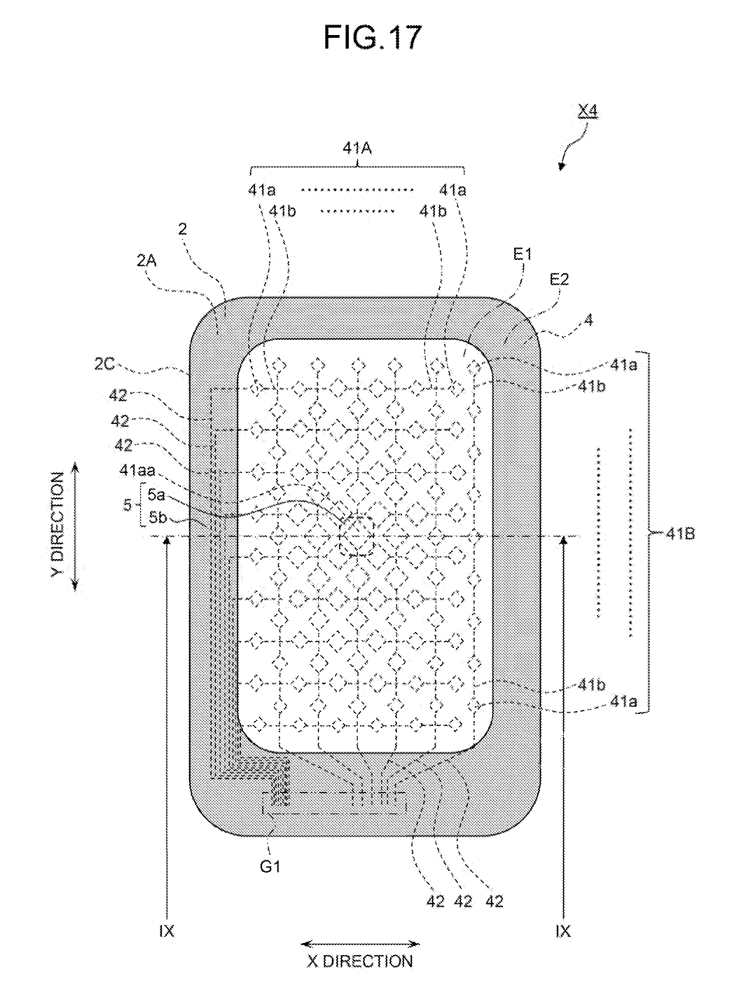

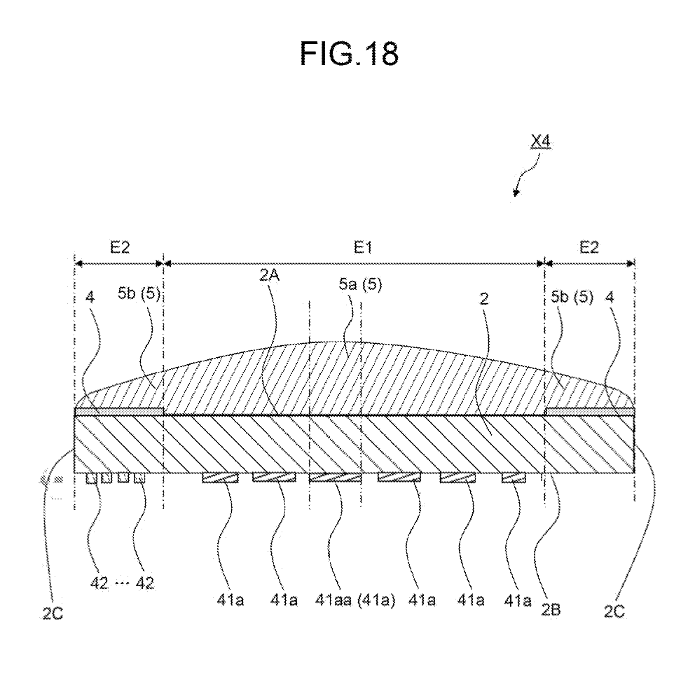

FIG. 17 is a plane view illustrating a schematic configuration of an input device X4 according to a third modified example. FIG. 18 is a cross-sectional view taken along line IX-IX of FIG. 17. In FIGS. 17 and 18, components having the same functions as in FIGS. 1 and 2 are denoted by the same reference numerals, and a detailed description thereof is omitted.

The input device X4 includes a position detecting member 41 instead of the position detecting member 3 equipped in the input device X1 as illustrated in FIGS. 17 and 18. The input device X4 further includes a detection interconnection 42.

The position detecting member 41 is provided on a portion of the second main surface 2B of the substrate 2 corresponding to the input region E1. The position defecting member 41 includes a plurality of detection electrodes 41a that form a capacitance with the user's finger and a plurality of inter-electrode interconnections 41b that electrically connect the plurality of the detection interconnection 42. The plurality of detection electrodes 41a and the plurality of inter-electrode interconnections 41b are classified into a plurality of first detection electrode patterns 41A and a plurality of second detection electrode patterns 41B.

The first detection electrode pattern 41A has a role to detect an input position in the Y direction. The first detection electrode pattern 41A includes a plurality of detection electrodes 41a arranged in the X direction and a plurality of inter-electrode interconnections 41b connecting the neighboring detection electrodes 41a, and the plurality of first detection electrode patterns 41A are arranged in the Y direction. The second detection electrode pattern 41B has a role to detect an input position in the X direction. the second detection electrode pattern 41B includes a plurality of detection electrodes 41a arranged in the Y direction and a plurality of inter-electrode interconnections 41b connecting the neighboring detection electrodes 41a, and the plurality of second detection electrode patterns 41B are arranged in the X direction. The inter-electrode interconnections 41b included in the first detection electrode pattern 41A and the inter-electrode interconnections 41b included in the second detection electrode pattern 41B are arranged with an insulator (not illustrated) interposed therebetween and electrically insulated.

Here, the detection electrode 41a corresponding to the apex portion 5a with the substrate 2 interposed therebetween among the plurality of detection electrodes 41a is referred to as a “target detection electrode 41aa.” Specifically, the target detection electrode 41aa refers to the detection electrode 41a overlapping the apex portion 5a at a planar view. Further, when there are a plurality of detection electrodes 41a overlapping the apex portion 5a at a planar view, the detection electrode 41a positioned at the side closest to the top of the apex portion 5a among the plurality of detection electrodes 41a may be recognized as the target detection electrode 41aa. In the input device X4, the detection electrode 41a corresponding to the edge portion 5b with the substrate 2 interposed therebetween is smaller in area size than the target detection electrode 41aa at a planar view. Thus, in the input device X4, it is possible to reduce a possibility that the detection accuracy of the operation position of the user will be lowered.

Specifically, the plurality of detection electrodes 41a are provided on the second main surface 2B of the substrate 2. The resin member 5 includes an apex portion 5a. and an edge portion 5b positioned outside the apex portion 5a. Thus, the separation distance from the surface of the apex portion 5a to the detection electrode 41a is different from the separation distance from the surface of the edge portion. 5b to the detection electrode 41a. Thus, when the user contacts the surface of the resin member 5 and performs the input operation, the capacitance generated between the finger contacting the surface of the apex portion 5a and the detection electrode 41a is likely to be relatively smaller than the capacitance generated between the finger contacting the surface of the edge portion 5b and the detection electrode 41a.

In this regard, in the input device X4, the detection electrode 41a corresponding to the edge portion 5b with the substrate 2 interposed therebetween is smaller in area size than the target detection electrode 41aa at a planar view. Thus, it is possible to reduce a possibility that the capacitance generated between the finger contacting the surface of the apex portion 5a and the detection electrode 41a will be relatively smaller than the capacitance generated between the finger contacting the surface of the edge portion 5b and the detection electrode 41a.

In the third modified example, the detection electrode 41a corresponding to the edge portion 5b refers to one of the plurality of detection electrodes 41a overlapping the edge portion 5b at a planar view. In other words, one of the plurality of detection electrodes 41a overlapping the edge portion 5b at a planar view is preferably smaller in area size than the target detection electrode 41aa at a planar view.

Further, as in the third modified example, preferably, the area sizes of the plurality of detection electrodes 41a at a planar view increase as the separation distance from the surface of the resin member 5 positioned on the first main surface 2A of the substrate 2 is increased. According to this configuration, it is possible to reduce a possibility that the capacitance generated in the detection electrode 41a will vary according to the operation position of the user. Thus, it is possible to further reduce a possibility that the detection accuracy of the operation position of the user will be lowered.

### FOURTH MODIFIED EXAMPLE

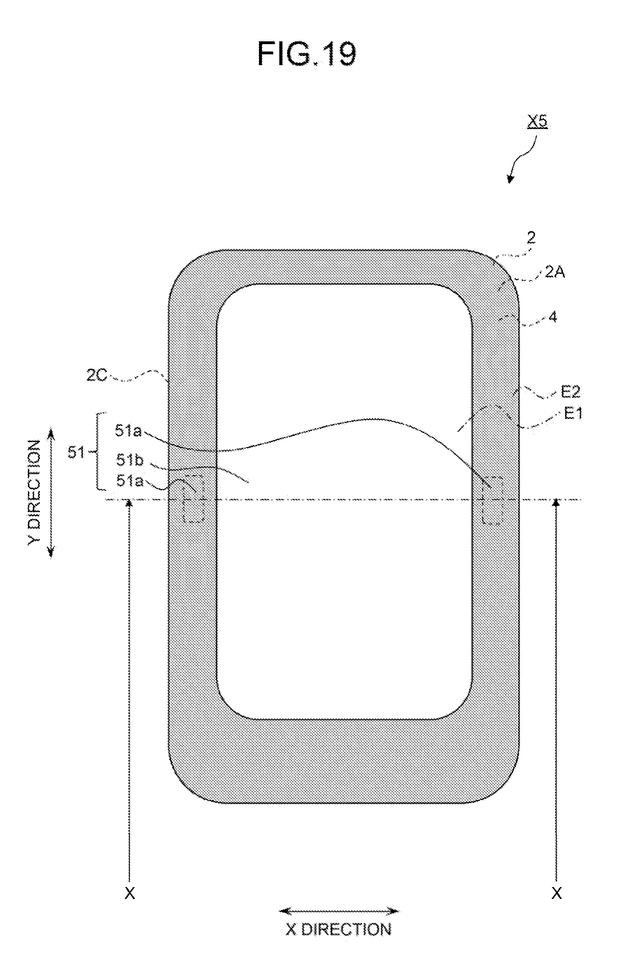

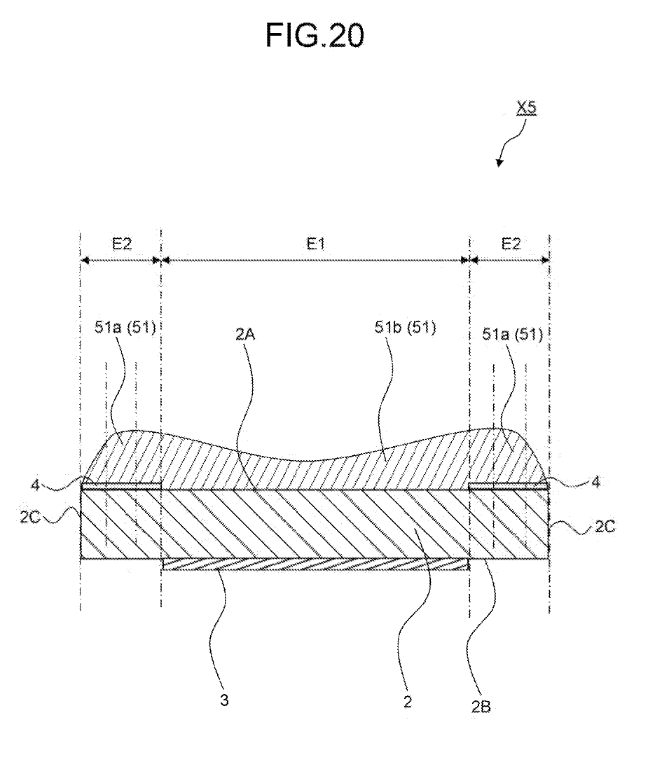

FIG. 19 is a plane view illustrating a schematic configuration of an input device X5 according to a fourth modified example. FIG. 20 is a cross-sectional view taken along line X-X of FIG. 19. In FIGS. 19 and 20, components having the same functions as in FIGS. 1 and 2 are denoted by the same reference numerals, and a detailed description thereof is omitted.

The input device X5 includes a resin member 51 instead of the resin member 5 equipped in the input device X1 as illustrated in FIGS. 19 and 20.

The resin member 51 is provided on the first main surface 2A of the substrate 2. The resin member 51 is formed in a convex shape in a direction getting away from the first main surface 2A of the substrate 2. Specifically, the resin member 51 includes two apex portions 51a. The two apex portions 51a are positioned on portions of the first main surface 2A of the substrate 2 corresponding to the non-input region E2, and face each other with the input region E1 interposed therebetween. An edge portion 51b is positioned outside the two apex portions 51a.

As described above, in the fourth modified example, the two apex portions 51a with the input region E1 interposed therebetween are positioned on the portions of the first main surface 2A of the substrate 2 corresponding to the non-input region E2. Thus, the resin member 51 positioned on the portion of the first main surface 2A of the substrate 2 corresponding to the input region E1 has a concave-shaped surface. Accordingly, in the input device X5, when the user performs the input operation on the surface of the resin member 51 corresponding to the input region E1, a tactile sense different from those of the input devices X1 to X4 can be given to the user.

The position of the apex portion 51a or the number of apex portions 51a is not particularly limited. For example, the four apex portions 51a may be formed corresponding to four corner portions of the substrate 2. Further, the apex portion 51a may be formed to surround the input region E1 on the portion of the first main surface 2A of the substrate 2 corresponding to the non-input region E2.

### FIFTH MODIFIED EXAMPLE

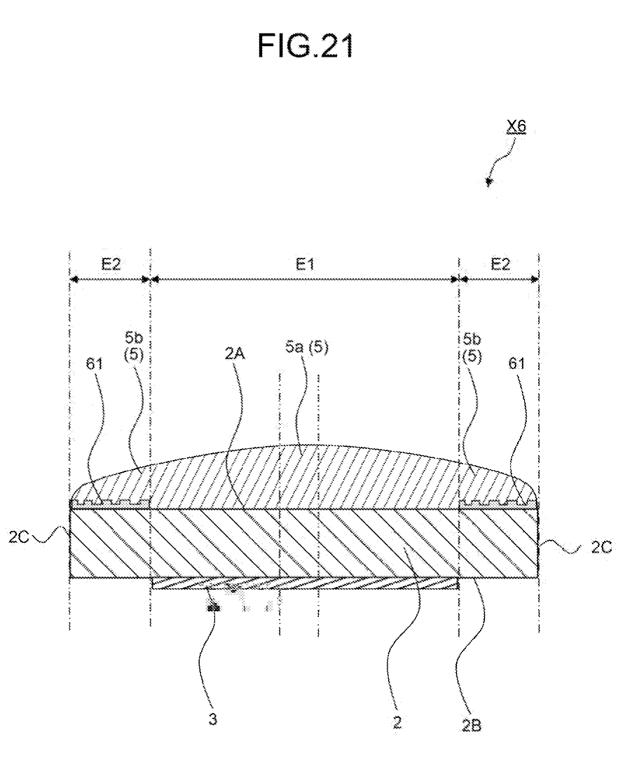

FIG. 21 is a plane view illustrating a schematic configuration of an input device X6 according to a fifth modified example. In FIG. 21, components having the same functions as in FIG. 2 are denoted by the same reference numerals, and a detailed description thereof is omitted.

The input device X6 includes a decorating member 61 instead of the: decorating member 4 equipped in the input device X1 as illustrated in FIG. 21. The decorating member 61 has a role to decorate the non-input region 22 of the input device X6 or has a role to light-shield the non-input region E2 of the input device X6. Here, the decorating member 61 has a concave-convex surface. Since the decorating member 61 has the concave-convex surface, it is possible to improve the design property of the input device X6, and it is possible to reduce a possibility that the resin member 5 will be peeled off from the decorating member 61.

### SIXTH MODIFIED EXAMPLE

In this specification, the above embodiment and the first to fifth modified examples have been individually and specifically described, but the present invention is not limited thereto, and an example in which matters individually described in the above embodiment and the first to fifth modified examples are appropriately combined has been described as well. In other words, an input, device according to the present invention is not limited to the input devices X1 to X6, and includes an input device in which matters individually described in the above embodiment and the first to sixth modified examples are combined,

Further, the present embodiment has been described in connection with the display device Y1 equipped with the input device X1, but the present invention is not limited thereto, and the input devices X2 to X6 may be employed instead of the input device X1. Moreover, the present embodiment has been described in connection with the mobile terminal Z1 equipped with the display device Y1, but the present invention is not limited thereto, and the display device Y2 may be employed instead of the display device Y1.

1. An input device, comprising:
a substrate including a first main surface and a second main surface positioned at a side opposite to the first main surface;
a position detecting member provided on the second main surface of the substrate; and
a resin member provided on the first main surface of the substrate,
wherein the resin member is formed in a convex shape in a direction getting away from the first main surface of the substrate.

2. The input device according to claim 1,
wherein the resin member includes an apex portion and an edge portion positioned outside the apex portion, and
a separation distance from a surface of the apex portion to the first main surface of the substrate is larger than a separation distance from a surface of the edge portion, to the first main surface of the substrate.

3. The input device according to claim 2,
wherein a portion of the edge portion is positioned outside the substrate at a planar view.

4. The input device according to claim 3,
wherein the portion of the edge portion is positioned to surround the substrate at a planar view.

5. The input device according to claim 2,
wherein the substrate includes an end surface positioned between the first main surface and the second main surface, and
the resin member is positioned to extend from the first main surface of the substrate to the end surface.

6. The input device according to claim 5,
wherein the end surface of the substrate on which the resin member is positioned is larger in surface roughness than the first main surface of the substrate on which the resin member is positioned.

7. The input device according to claim 5,
wherein the end surface of the substrate includes a convex portion or concave portion.

8. The input device according to claim 5,
wherein the resin member positioned on the end surface of the substrate has a convex surface.

9. The input device according to claim 2,
wherein the position detecting member includes a plurality of detection electrodes, and
when the detection electrode corresponding to the apex portion with the substrate interposed therebetween among the plurality of detection electrodes is recognized as a target detection electrode,
the detection electrode corresponding to the edge portion with the substrate interposed therebetween is smaller in area size than the target detection electrode at a planar view.

10. The input device according to claim 9,
wherein area sizes of the plurality of detection electrodes at a planar view increase as a separation distance from a surface of the resin member positioned on the first main surface of the substrate is increased.

11. The input device according to claim 1,
wherein the resin member positioned on the first main surface of the substrate has a rounded surface.

12. The input device according to claim 11,
wherein the resin member positioned on the first main surface of the substrate has a spherical surface.

13. The input device according to claim 1,
wherein the substrate is made of glass or plastic.

14. A display device, comprising:
the input device according to claim 1;
a display panel arranged to face the second main surface of the substrate in the input device; and
a first housing accommodating the display panel.

15. The display device according to claim 14,
wherein the substrate includes an end surface positioned between the first main surface and the second main surface,
the first housing includes a base portion facing the second main surface of the substrate and a frame portion positioned to surround the end surface of the substrate, the display panel being placed on the base portion, and
a height position of an upper surface of the frame portion, with respect to the base portion is substantially the same as or higher than a height position of the first main surface of the substrate with respect to the base portion.

16. The display device according to claim 14,
wherein the substrate includes an end surface positioned between the first main surface and the second main surface,
the first housing includes a base portion lacing the second main surface of the substrate and a frame portion positioned to surround the end surface of the substrate, the display panel being placed on the base portion, and
a portion of the edge portion is positioned to be closer to the frame portion side than the end surface of the substrate at a planar view and adjacent to the frame portion.

17. An electronic apparatus, comprising;
the display device according to claim 14,
wherein the first housing in the display device functions as a housing for the electronic apparatus.

18. An electronic apparatus, comprising;
the display device according to claim 14; and
a second housing accommodating the display device.

19. The electronic apparatus according to claim 17, further comprising;
a voice input unit that receives a voice;
a voice output unit that outputs a voice; and
a control unit that controls the voice input unit and the voice output unit.

20. The electronic apparatus according to claim 18, further comprising:
a voice input unit that receives a voice;
a voice output unit that outputs a voice; and
a control unit that controls the voice input unit and the voice output unit.
